(19) United States
(12) Patent Application Publication
(10) Pub. No.: US 2024/0420094 A1
(43) Pub. Date: Dec. 19, 2024

(54) SYSTEMS AND METHODS FOR WINDSHIELD DAMAGE IDENTIFICATION AND RECOMMENDATION

(71) Applicant: State Farm Mutual Automobile Insurance Company, Bloomington, IL (US)

(72) Inventors: Anjela Spreen, Hewitt, TX (US); Geetha P. Nagarajan, Plano, TX (US); Reuven Birnbaum, Urbana, IL (US); Shyam Tummala, Frisco, TX (US); Hariprakash T. Ejilane, Allen, TX (US)

(21) Appl. No.: 18/504,747

(22) Filed: Nov. 8, 2023

Related U.S. Application Data
(60) Provisional application No. 63/507,842, filed on Jun. 13, 2023.

(51) Int. Cl. G06Q 10/20; G06Q 10/1093

(52) U.S. Cl. CPC G06Q 10/20; G06Q 10/1095

(57) ABSTRACT

A damage assessment (DA) computing device including at least one memory and at least one processor is disclosed. The at least one processor of the DA computing device is programmed to receive, from a client device, data representing a glass related damage claim, and determine characteristics of the damage to the glass by analyzing the received data. The characteristics of damage include at least a type of the damage, and a size of the damage. The at least one processor is programmed to determine, based upon the determined characteristics of the damage, a type of repair to fix the damage, and communicate, to the client device, the determined type of repair to fix the damage. The at least one processor is programmed to prompt a user of the client device to accept the type of repair including facilitating scheduling of an appointment to complete the type of repair.

### CROSS-REFERENCE TO RELATED APPLICATIONS

This application claims priority to U.S. Provisional Patent Application Ser. No. 63/507,842, filed Jun. 13, 2023, the entire contents and disclosure of which are hereby incorporated herein by reference in its entirety.

### FIELD OF THE DISCLOSURE

The present disclosure generally relates to determining damage to a windshield and, more particularly, to computer network-based systems and methods for determining damage to a windshield and provide a recommendation to repair or replace the windshield based upon the determined damage.

### BACKGROUND

Windshields may sustain damage due to fire, wind, hail, flood, theft, vandalism, falling objects, and various other events. Windshield repairs and replacements should be done as soon as possible to prevent the damage from getting worse. In certain situations, windshield damage may be covered by an insurance policy. However, insurance companies may rely on third-party glass companies to make the determination as to whether a damaged windshield needs to be repaired or replaced. In general, windshield replacement may cost the customer (and/or the insurance company) a lot more than a simple repair. Currently, the determination may rely on the expertise and legitimacy of the third-party company and may vary among third-party glass companies.

Accordingly, there exists a need to quickly, accurately, and consistently determine damage to a windshield to improve repair outcomes and minimize cost. Conventional techniques may have other inefficiencies, ineffectiveness, encumbrances, and/or drawbacks as well.

### BRIEF SUMMARY

The present embodiments may relate to, inter alia, a damage assessment (DA) system for determining a severity of damage to a windshield and to generate, using artificial intelligence-based tools and image recognition tools, a repair or replace recommendation.

In one aspect, a damage assessment (DA) computing device including at least one memory and at least one processor in communication with the at least one memory may be provided. The computing device may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computing device may include at least one processor programmed to: (i) receive, from a client device communicatively coupled with the DA computing device, data representing a glass related damage claim. The at least one processor may be further programmed to (ii) determine characteristics of the damage to the glass by analyzing the received data, and (iii) based upon the determined characteristics of the damage, determine a type of repair to fix the damage. The characteristics of the damage may include a type of the damage and a size of the damage. The at least one processor may be further programmed to (iv) communicate, with the client device, the determined type of repair to fix the damage, and/or (v) prompt a user of the client device to accept the type of repair including facilitating scheduling of an appointment to fix the damage. The DA computing device may include additional, less, or alternate functionality, including that discussed elsewhere herein.

In another aspect, a computer-implemented method for damage assessment may be provided. The method may be implemented via one or more local or remote processors, servers, transceivers, sensors, memory units, mobile devices, wearables, smart glasses, smart watches, augmented reality glasses, virtual reality headsets, mixed or extended reality devices, voice bots, chat bots, Chat-GPT bots, and/or other electronic or electric components, which may be in wired or wireless communication with one another. In one instance, the method may include (i) receiving, at a damage assessment (DA) computing device from a client device communicatively coupled with the DA computing device, data representing a windshield related damage claim. The method may include (ii) determining characteristics of the damage to the glass based upon the received data. The characteristics of the damage may include at least a type of the damage and a size of the damage. The method may include (iii) determining a type of repair to fix the damage based upon the determined characteristics of the damage, and/or (iv) transmitting, from the DA computing device to the client device, the determined type of repair to fix the damage. The method may include (v) prompting a user of the client device to accept the type of repair including facilitating scheduling of an appointment to fix the damage. The method may include additional, less, or alternate functionality, including that discussed elsewhere herein.

In yet another aspect, a non-transitory computer-readable storage media may be provided. The computer-readable storage media having computer-executable instructions embodied thereon, which when executed by at least one processor, cause the at least one processor to (i) receive and analyze data representing a glass related damage claim, and (ii) based upon the analyzed data, determine characteristics of the damage to the glass. The characteristics of the damage may include at least a type of the damage and a size of the damage. The computer-executable instructions cause the at least one processor to (iii) determine a type of repair to fix the damage. The type of repair to fix the damage is determined based upon the determined characteristics of the damage. The computer-executable instructions cause the at least one processor to (iv) communicate the determined type of repair to fix the damage to a submitter of the glass related damage claim and/or (v) prompt the submitter to accept the type of repair including facilitating scheduling of an appointment to fix the damage. The instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 depicts an exemplary configuration of a user computing device, in accordance with one embodiment of the present disclosure.

FIG. 2 depicts an exemplary configuration of an application server of a backend system, in accordance with one embodiment of the present disclosure.

FIG. 3 depicts various types of damage to a windshield.

FIG. 4 depicts a flow-chart of exemplary computer-implemented method operations performed by the application server of the backend system, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, computer systems and computer-implemented methods for assessing damage to a windshield and providing a recommendation to repair or replace the windshield based upon the assessed damage. Even though, various embodiments are described herein corresponding to a windshield of a vehicle, the embodiments may also be related to damage to other types of glass of a vehicle. The vehicle may be a car, a truck, a bus, a motorbike, a vehicle, an aircraft, a flying taxi, a motorcycle, a recreational vehicle, and so on. Even though, not described in detail herein, the embodiments, as described herein, may be applicable to windshield repair and/or replacement for other types of vehicles, e.g., airplane, a boat, and so on. The system could also be used for assessing damage to other glass items whether on a vehicle or not.

Windshields may sustain damage due to fire, wind, hail, flood, theft, vandalism, falling objects, and various other events. Windshield repairs and replacements should be done as soon as possible to prevent the damage from getting worse, and also for the safety of a driver and/or a passenger in the vehicle. In certain situations, windshield damage may be covered by an insurance policy. However, insurance companies typically rely on a third-party glass company to make the determination as to whether a damaged windshield needs to be repaired or replaced. In general, windshield replacement costs the customer (and/or the insurance company) a lot more than a simple repair job. Currently, the determination relies on the expertise and legitimacy of the third-party company and may vary among third-party glass companies.

Accordingly, various embodiments, as described herein, may quickly, accurately, and consistently assess damage to a windshield, and based upon the assessed damage, provide a recommendation to repair or replace the windshield that would improve repair outcomes and minimize cost to both a vehicle owner and the insurance company. Further, the embodiments, as described herein, may help the vehicle owner to receive the most appropriate recommendation without leaving his or her home, any time of the day/night. The vehicle owner may also schedule an appointment for repair or replacement of the windshield at a glass repair shop that matches criteria set by the vehicle owner and/or the insurance company.

In some embodiments, upon a windshield of a vehicle being damaged, for example, from any reason including, but not limited to, fire, wind, hail, flood, theft, vandalism, falling objects, road debris, a difference in temperature between outside the vehicle and inside of the vehicle, and so on, a vehicle owner may launch an application executing on the vehicle owner's client device. By way of a non-limiting example, the client device may be a phone (or a smart phone), a tablet, a laptop, a smartwatch, a smart glass, an Internet-of-Things, a mobile device, augmented reality (AR) glasses, virtual reality (VR) headset, wearables, smart glasses or contacts, one or more bots (voice bots, chat bots, ChatGPT bots, etc.), machine learning-based devices, generative AI devices, and so on.

The client device may include at least a vision sensor, at least one processor, at least one memory, and/or at least one communication interface connecting the client device executing the application to a backend system executing another application. The application executing on the client device may be referenced herein as a frontend application, and the application executing on the backend system may be referenced herein as a backend application. The frontend application and the backend application may be communicatively coupled with each using a wired and/or a wireless communication network, for example, a 3G network, a 4G network, a 5G network, a 6G network, a local area network (LAN), a wide area network (WAN), an Internet, and/or a satellite network, and so on.

The client device, via the frontend application, may communicate data with the backend application executing on the backend system, and may receive communication from the backend application. The data communicated from the client device to the backend system may include one or more images, one or more video data files, text, and/or voice, and so on. The data may be communicated from the client device to the backend system via a webservice message over a hypertext transfer protocol (http) or a hypertext transfer protocol secure (https) protocol. The webservice message from the frontend application executing on the client device may, for example, be according to a Representational State Transfer (REST) application programming interface (API) and/or a Simple Object Access Protocol (SOAP) API. The data may be communicated from the client device to the backend system as (i) an extended markup language (XML), (ii) a JavaScript Object Notation (JSON), (iii) a Concise Binary Object Representation (CBOR), (iv) hypertext markup language (html), (v) a binary JSON (BSON), (vi) protocol buffers, and (vii) via other programming languages or protocols.

In some embodiments, a vehicle owner may launch an instance of a frontend application on the vehicle owner's client device. An interface view may be displayed on the vehicle owner's client device prompting the user (e.g., the vehicle owner) to select an option corresponding to a glass coverage claim. Upon the vehicle owner selecting the option corresponding to the glass coverage claim, the vehicle owner may select an option corresponding to a new glass coverage claim. Upon selecting the new glass coverage claim, the vehicle owner may provide details, such as, a date of an incident, a time of the incident, a location where the incident occurred, details of a vehicle, confirmation of vehicle details, and/or description of damage to a windshield, and so on. Upon receiving responses/details from the vehicle owner, the vehicle owner may be asked to submit visual data corresponding to damage to a windshield of the vehicle owner's vehicle.

In some cases, when the vehicle owner may not be available to provide visual data corresponding to damage to the windshield, the vehicle owner may save data for the new glass coverage claim. The vehicle owner may select an existing claim (e.g., an existing glass coverage claim) to submit visual data corresponding to damage to the windshield at a later date and/or time.

In some embodiments, upon the vehicle owner indicating that the vehicle owner is available to submit visual data corresponding to damage to the windshield, the frontend application may activate at least one visual sensor of the client device. By way of a non-limiting example, the at least one visual sensor may be a still camera or a video camera. The vehicle owner may be asked to take one or more still images and/or one or more video reels using the still camera or the video camera, respectively.

In some examples, the vehicle owner may be asked to take an image of an entire front area of the vehicle and/or an entire area of a windshield of the vehicle. The vehicle owner may be asked to capture an image corresponding to a damaged area on the windshield. Using the vehicle information, a particular physical dimension of the windshield may be obtained. Based upon an image of the windshield covering the entire physical dimension of the windshield, an image of the damaged area on the windshield, and pixel information of each image taken by the at least one visual sensor of the client device, a particular dimension/size of the damaged area may be identified or determined.

In one example, the system, using pixel information of an image and particular physical dimension of the windshield, may identify or determine a number of pixels corresponding to the damaged area. Based upon the number of pixels corresponding to the damaged area, dimensions of the damaged area may be identified by the system. Additionally, or alternatively, metadata of an image including, but not limited to, sensor image size (or physical sensor size), width and height in pixels, a focal length of a lens, a distance from the vehicle (or windshield) at which the image is taken, and so on, may also be used to determine dimensions of the damaged area on the windshield.

In some examples, upon the vehicle owner indicating that the vehicle owner is available to submit visual data corresponding to damage to the windshield, the frontend application may activate another application, e.g., a ruler camera application, an augmented reality (AR) ruler app, and so on, generally referenced herein as a ruler camera application, installed on the client device. The vehicle owner may be asked to capture one or more still images and/or one or more video reels using the ruler camera application. Based upon an image captured using the ruler camera application, and physical dimension of the windshield obtained from the vehicle information, dimensions of a damaged area on the windshield may be determined.

In some examples, the vehicle owner may be asked to capture an image of an entire windshield, and/or a damaged area on the windshield along with a reference object that is placed on the windshield, for example, near the damaged area on the windshield, or anywhere on the windshield. By way of a non-limiting example, the reference object may be a coin with its size generally known, or any other object whose size may be known easily. Based upon the images taken along with the reference object, dimensions of the damaged area on the windshield may be determined or calculated.

All images and their corresponding data (and/or metadata) may be transmitted to the backend application for determining dimension of the damaged area, location of the damaged area on the windshield, severity of the damaged area, a type of the damage, and/or an adverse impact on a safety feature of the windshield (e.g., speed and/or compass display on the windshield, navigational directions display on the windshield, and so on) among other aspects related to the damage.

In some embodiments, the frontend application may display instructions to the vehicle owner regarding which images may be taken and how these images to be taken. The vehicle owner may take one or more images as instructed by the frontend application, and then transmit or upload the one or more images saved, for example, on the client device, using the frontend application.

In some embodiments, the backend application may analyze the received one or more images, and/or other details from the frontend application, as described herein, to determine dimension of the damaged area of the windshield. Also, a specific location of the damage on the windshield, and/or a type of the damage may also be identified. By way of a non-limiting example, the type of the damage may be categorized as one of a long crack, a bull's eye crack, a star crack, a half-moon crack, and so on. For each different type of the damage, a different dimension of the damage may require a different type of repair job (e.g., repair of the windshield, or replacement of the windshield).

In some embodiments, and by way of a non-limiting example, if the determined damage type is a long crack, which is at least a first length value long, then a recommendation to replace the windshield may be made instead of repairing the windshield. The first length value may be 15 centimeters. If the first length value is less than 15 centimeters, then repair may be recommended by the system. If the determined damage type is a bull's eye crack, which has a diameter of at least a second length value, then a recommendation to replace the windshield may be made instead of repairing the windshield. The second length value may be 2 centimeters. If the second length value is less than 2 centimeters, then repair may be recommended by the system. If the determined damage type is a star crack, which has a diameter of at least a third length value, then a recommendation to replace the windshield may be made instead of repairing the windshield by the system. The third length value may be 3 centimeters. If the third length value is less than 3 centimeters, then repair may be recommended by the system. If the determined damage type is a half-moon crack, which has a diameter of at least a fourth length value, then a recommendation to replace the windshield may be made instead of repairing the windshield by the system. The fourth length value may be 2.5 centimeters. If the fourth length value is less than 2.5 centimeters, then repair may be recommended by the system.

The determined recommendation may be communicated by the backend application to the frontend application. By way of a non-limiting example, the determined recommendation may be displayed on the client device as a notification or a message to the client device. The determined recommendation may be displayed as an in-app notification (for example, an alert notification with the frontend application), and/or as an overlay showing the recommendation.

Additionally, or alternatively, the vehicle owner may also be asked if the vehicle owner would like to schedule an appointment with a glass repair shop based upon the recommendation. Upon receiving confirmation or approval from the vehicle owner that the vehicle owner prefers to schedule the appointment with the glass repair shop according to the recommendation, the frontend application may display a list of glass repair shops within a certain distance from the vehicle owner's current and/or preferred location (that is different from the vehicle owner's current location) as received from the backend application. The list of glass repair shops may include an insurance company authorized or unauthorized glass repair shop. In some examples, available appointment date(s) and time(s) for each glass repair shop of the list of glass repair shops may also be displayed on the frontend application.

Upon the vehicle owner selecting a particular glass repair shop, an appointment date and time, an appointment for windshield repair or replacement is automatically made by the backend application, and confirmation details may be sent to the vehicle owner, for example, as a text message, an email, and/or an appointment scheduled in a calendar application on the vehicle owner's client device.

In some embodiments, if a particular damage type and/or dimensions of the damage type may not be identified using the visual data received from the frontend application, then the vehicle owner may be requested to take the vehicle to any glass repair shop of the list of glass repair shops identified above. As described herein, the vehicle owner may schedule an appointment with a glass repair shop of the list of glass repair shops, as described herein.

In some embodiments, the backend application may determine dimension of the damaged area of the windshield, a type of the damage, a location of the damage on the windshield, severity of the damage, and/or a particular recommendation (e.g., repair or replacement) using an algorithm and/or a machine-learning model. The algorithm and/or the machine-learning model may use historical claims data including historical images of damage to windshields, and/or data identifying which of the repair or replacement is the most appropriate solution for each historical claim. By way of a non-limiting example, which of the repair or replacement is the most appropriate solution may be determined by the insurance company (and not the third-party glass repair shops) based upon auditing of the historical claims data. The visual data received from the frontend application and corresponding to the vehicle owner's claim may be analyzed (using image analysis) and compared by the algorithm and/or the machine-learning model with historical images and adjudications of previous claims to determine an appropriate recommendation. The machine-learning model may be a supervised or an unsupervised machine-learning algorithm. By way of a non-limiting example, the machine-learning model may be a computer vision model, which may have been trained to identify one or more objects and/or their dimensions by analysis of an image.

The various embodiments of the present disclosure thus provide a technical solution that includes an intelligent system that correctly and timely remedy a vehicle owner's claims using the vehicle owner's client device and a backend system. The system identifies and assess the damage using image analysis and AI tools while saving time and money for both the vehicle owner and the insurance company. These embodiments are described in greater detail using the figures described below.

The systems and methods described herein address at least the aforementioned issues, e.g., lack of consistency and accuracy regarding windshield damage assessments. More particularly, the systems and methods disclosed herein use historical windshield damage data and image analysis to accurately determine windshield damage severity and to provide a recommendation of repair or replacement of the windshield based upon the severity.

A damage assessment (DA) computing system is described herein that is configured to receive and analyze windshield incident information. Based upon analysis of the windshield incident information, accurate and consistent windshield damage assessments may be made. Accurate and consistent windshield damage assessment may help reduce costs associated with windshield damage and improve the outcome for repairing the windshield.

The DA computing system may receive and analyze windshield incident data, including, but not limited to, text data, image data, video data, and/or audio data as will be described in more detail below. For example, users may submit photographs, videos, and the like, to an application. The DA computing system may also receive dimension information of a windshield of a vehicle insured by the insurance company. The dimension information may be acquired or obtained by the DA computing system based upon a make, a model, and a year of manufacture details for the insured vehicle. The dimension information may be stored in a local database or a remote database, such as a database in a cloud network. Additionally, or alternatively, the dimension information may be received via an application programming interface (API) call to a third-party system.

In some embodiments, the DA computing system may use computer vision or optical character recognition to analyze photographs and/or still images obtained from a video to confirm and assess damage to a windshield of a vehicle. In some embodiments, after damage is confirmed, an insurance claim may be automatically generated, as discussed in more detail below.

Currently, after an event that results in damage to a windshield of a motor vehicle of a policyholder, the policyholder may submit a claim. Conventional claim processing events include submission of a claim and an in-person inspection by a third-party glass repair company to assess the property damage. In some cases, when only repair may be needed, a replacement of the windshield may be performed. Thus, conventional claim processing events may be both costly and time consuming.

### Exemplary Computing Device

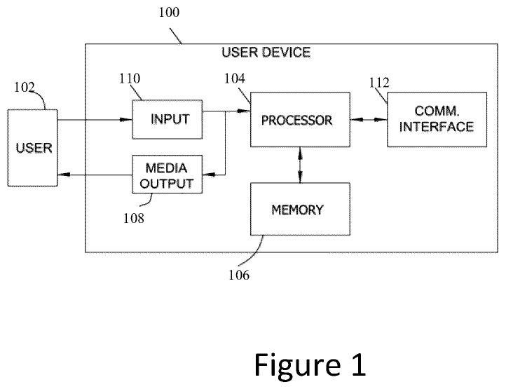

FIG. 1 depicts an exemplary configuration of a user computing device 100, in accordance with one embodiment of the present disclosure. User computing device 100 may be operated by a user 102, such as policyholder. User computing device 100 may include, but is not limited to, a smart phone, a tablet, a laptop, an electronic device equipped with at least one visual sensor. Additionally, or alternatively, user computing device 100 may be, for example, a mobile device, smart home controller, smart vehicle, smart watch, smart contact lenses, augmented reality glasses, virtual reality headset, mixed or extended reality headset or glasses, wearables, voice or chat bot, other input device, and/or other electronic or electrical devices.

User computing device 100 may include a processor 104 for executing instructions. In some embodiments, executable instructions may be stored in a memory 106. Processor 104 may include one or more processing units (e.g., in a multi-core configuration). Memory 106 may be any device allowing information such as executable instructions and/or transaction data to be stored and retrieved. Memory 106 may include one or more computer readable media.

User computing device 100 may also include at least one media output component 108 for presenting information to user 102. Media output component 108 may be any component capable of conveying information to user 102. In some embodiments, media output component 108 may include an output adapter (not shown) such as a video adapter and/or an audio adapter. An output adapter may be operatively coupled to processor 104 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 108 may be configured to present a graphical user interface (e.g., a web browser and/or a client application) to user 102. A graphical user interface may include, for example, an interface for viewing prompts and data. In some embodiments, user computing device 100 may include an input (or an input device) 110 for receiving input from user 102. User 102 may use input 110 to, without limitation, provide user input.

Input device 110 may include, for example, a keyboard, a pointing device, a mouse, a stylus, a touch sensitive panel (e.g., a touch pad or a touch screen), a gyroscope, an accelerometer, a position detector, a biometric input device, at least one vision sensor (e.g., a camera or a video camera), and/or an audio input device. A single component such as a touch screen may function as both an output device of media output component 108 and input device 110.

User computing device 100 may also include a communication interface 112, communicatively coupled to a backend system or an application server, which may be configured to receive and process data regarding claims for windshield repair. Communication interface 112 may include, for example, a wired or wireless network adapter and/or a wireless data transceiver for use with a mobile telecommunications network.

Stored in memory 106 are, for example, computer readable instructions for providing a user interface to user 102 via media output component 108 and, optionally, receiving and processing input from input 110. A user interface may include, among other possibilities, a web browser and/or a client application. Web browsers enable users, such as user 102, to display and interact with media and other information typically embedded on a web page or a website from the backend system. A client application (e.g., a frontend application executing on the user computing device 100) may allow user 102 to interact with, for example, the backend system.

In one embodiment, the user computing device 100 may be part of a computer system. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include the user device 100 and/or a server computing device that may include at least one processor in communication with at least one memory device.

In another embodiment, user computing device 100 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In some embodiments, generative artificial intelligence (AI) models (also referred to as generative machine learning (ML) models) may be utilized with the present embodiments, and the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by and/or used in conjunction with reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text, or textual output, visual or graphical output, output for use with speakers and/or display screens, and/or other types of output for user and/or other computer or bot consumption.

### Exemplary Application Server

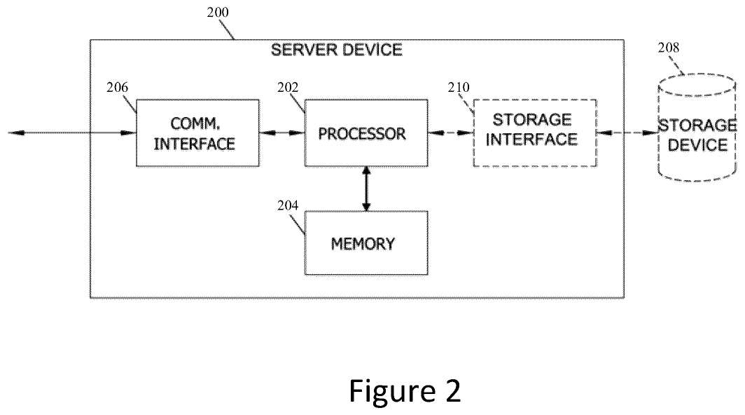

FIG. 2 depicts an exemplary configuration of an application server 200 of a backend system, in accordance with one embodiment of the present disclosure. Application server 200 may be configured to perform various steps, as described herein, from the backend system perspective, for example, receiving and analyzing data and/or claim details from a vehicle owner's client device; identifying a type, dimensions, and/or severity of a damage to a windshield; and determining how to remedy the claim, for example, replace or repair the windshield, and so on, using an algorithm or a machine-learning model. The application server 200 may also include a processor 202 for executing instructions. Instructions may be stored in a memory 204. Processor 202 may include one or more processing units (e.g., in a multi-core configuration).

Processor 202 may be operatively coupled to a communication interface 206 such that the application server 200 is capable of communicating with a remote device, such as another application server 200 and/or user computing device 100, for example, using wireless communication or data transmission over one or more radio links or digital communication channels. For example, communication interface 206 may receive data, e.g., image, video, text, and so on.

Processor 202 may also be operatively coupled to a storage device 208. Storage device 208 may be any computer-operated hardware suitable for storing and/or retrieving data, such as, but not limited to, data associated with historic databases. In some embodiments, storage device 208 may be integrated in the application server 200. For example, the application server 200 may include one or more hard disk drives as storage device 208.

In other embodiments, storage device 208 may be external to host computing device 200 and may be accessed by a plurality of host computing devices 200. For example, storage device 208 may include a storage area network (SAN), a network attached storage (NAS) system, and/or multiple storage units such as hard disks and/or solid-state disks in a redundant array of inexpensive disks (RAID) configuration.

In some embodiments, processor 202 may be operatively coupled to storage device 208 via a storage interface 210. Storage interface 210 may be any component capable of providing processor 202 with access to storage device 208. Storage interface 210 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 202 with access to storage device 208.

Processor 202 may execute computer-executable instructions for implementing aspects of the disclosure. In some embodiments, the processor 202 may be transformed into a special purpose microprocessor by executing computer-executable instructions or by otherwise being programmed.

In some embodiments, and by way of a non-limiting example, the memory 204 may include instructions corresponding to one or more modules or engines configured to perform specific operations. For example, the memory 204 may include instructions corresponding a damage severity engine, a repair/replacement recommendation engine, and/or a machine-learning training/validation engine.

The damage severity engine may be configured to determine severity of the damage based upon a type of damage and/or a dimension of the damage to the windshield. The damage severity engine may also consider location of the damage on the windshield as determined based upon the vehicle owner submitted visual data and/or other type of responses including text, audio, and/or video data submitted by the vehicle owner as response to a questionnaire to determine severity of the damage. In some examples, the severity of damage may be generated as a score value.

The repair/replacement recommendation engine may generate recommendation based upon the score value corresponding to the severity of damage. Based upon the damage having its severity score value that meets a particular threshold value, for example, 75 (out of maximum 100), the repair/replacement recommendation engine may recommend replacement of the windshield instead of repair of the windshield.

The damage severity engine may be based upon an algorithm and/or a machine-learning model, which may be trained using a machine-learning training/validation engine. The machine-learning training/validation engine may generate, train, and/or deploy a machine-learning model using historical claims data including, but not limited to, images of different types of damage, previous claim processing and/or audit history, and so on. The machine-learning model may be supervised and/or unsupervised machine-learning model. The machine-learning model may be a computer vision model trained to detect a damage on a windshield, a size/dimension of the damage, a type of damage, and/or a location of damage on the windshield, and so on. The machine-learning model may be a computer vision model trained to determine a repair or replacement decision, a repair cost, a repair service provider, a replacement cost, a replacement service provider, and so on. The historical claim data may be stored in database (a local database and/or a cloud database).

### Exemplary Windshield Damage

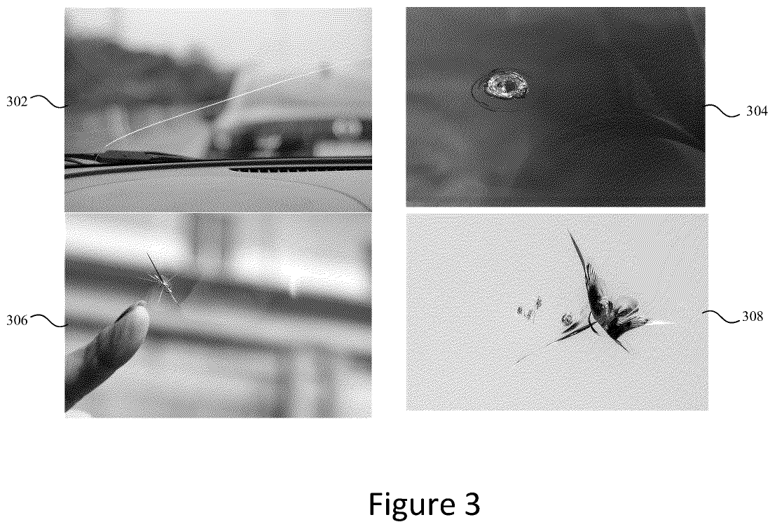

FIG. 3 illustrates various types of damage to a windshield. For example, different types of damage to a windshield may be of a long crack 302, a bull's eye crack 304, a star crack 306, a half-moon crack 308, and so on. Depending on dimensions of the particular damage, a type of the damage, and/or a location of the damage on the windshield, either repairing of the windshield or replacement of the windshield may be recommended and/or determined. By way of a non-limiting example, if the determined damage type is a long crack 302, which is at least a first length value long, then a recommendation is outputted by the system to replace the windshield may be made instead of repairing the windshield. The first length value may be 15 centimeters. If the first length value is less than 15 centimeters, then repair may be recommended by the system. In other embodiments, if the first length value is about 15 centimeters and/or greater, then the windshield is recommended to be replaced. In contrast, if the first length value is less than about 15 centimeters, then the windshield is recommended to be repaired.

If the determined damage type is a bull's eye crack 304, which has a diameter of at least a second length value, then a recommendation to replace the windshield may be made instead of repairing the windshield by the system. The second length value may be 2 centimeters. If the second length value is less than 2 centimeters, then repair may be recommended by the system. In other embodiments, if the second length value is about 2 centimeters and/or greater, then the windshield is recommended to be replaced. In contrast, if the second length value is less than about 2 centimeters, then the windshield is recommended to be repaired.

If the determined damage type is a star crack 306, which has a diameter of at least a third length value, then a recommendation outputted by the system to replace the windshield may be made instead of repairing the windshield. The third length value may be 3 centimeters. If the third length value is less than 3 centimeters, then repair may be recommended by the system. In other embodiments, if the third length value is about 3 centimeters and/or greater, then the windshield is recommended to be replaced. In contrast, if the third length value is less than about 3 centimeters, then the windshield is recommended to be repaired.

If the determined damage type is a half-moon crack 308, which has a diameter of at least a fourth length value, then a recommendation outputted by the system to replace the windshield may be made instead of repairing the windshield. The fourth length value may be 2.5 centimeters. If the fourth length value is less than 2.5 centimeters, then repair may be recommended by the system. In other embodiments, if the fourth length value is about 2.5 centimeters and/or greater, then the windshield is recommended to be replaced. In contrast, if the fourth length value is less than about 2.5 centimeters, then the windshield is recommended to be repaired.

### Exemplary Computer-Implemented Method

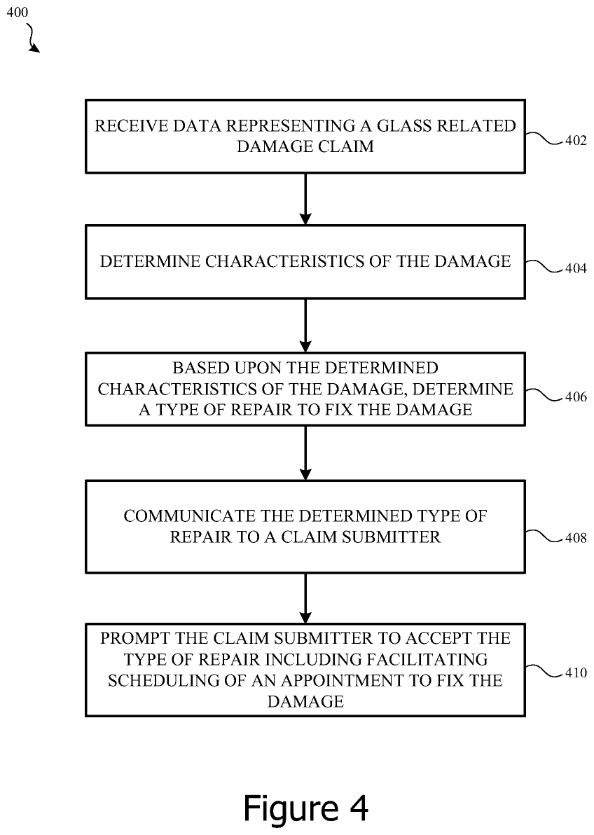

FIG. 4 depicts a process flow-chart 400 of example computer-implemented method operations performed by an application server of the backend system (which is shown in FIG. 2), in accordance with one embodiment of the present disclosure. As shown in the flow-chart 400, at 402, the application server may receive data related to a glass or windshield related damage claim. The data may be received by the application server that is communicatively coupled with a client device of a claim submitter. The data may include visual data and/or text data. Visual data may include one or more images, one or more video reels, and so on. The text data may include responses to a questionnaire by the claim submitter. By way of a non-limiting example, the glass related damage claim may be related to a damage to a windshield of a vehicle.

At 404, characteristics of the damage may be determined or identified by the at least one processor by analyzing the received data. By way of a non-limiting example, the received data (e.g., visual data) may be analyzed using one or more machine-learning models (e.g., one or more computer vision models), which are trained to detect a damage in the visual data, identify different characteristics of the damage including, but not limited to, a type of a damage, a size or a dimension of the damage, a location of the damage on the windshield, and so on. Characteristics of the damage may also include a severity score, which may be determined based upon the type of the damage, the size or dimension of the damage, and/or the location of the damage on the windshield.

At 406, in accordance with the determined characteristics of the damage, for example, the type of the damage and the size (or dimension) of the damage, a type of repair to fix the damage may be determined by the at least one processor, as described herein. The type of damage may include a long crack, a bull's eye crack, a star crack, or a half-moon crack, and based upon the size of the damage, the type of repair may be determined as a repair job or a replacement job. Since whether to fix the damage by replacing the windshield or repairing the windshield is described in detail in the present disclosure, those details are not repeated for brevity.

At 408, the determined type of repair may be communicated to the claim submitter as a notification and/or an alert, as described herein. At 410, the claim submitter (or the vehicle owner) may be prompted to accept the type of repair including assisting the user with scheduling of an appointment to complete the type of repair. In response to receiving an acknowledgement or a confirmation that the claim submitter prefers to get the particular damage fixed in accordance with the recommended type of repair, an appointment to complete the determined type of repair may be scheduled.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, the user computing device and/or the backend system is configured to implement machine learning, such that the system “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of images with known characteristics or features. Such information may include, for example, information associated with a plurality of images of a plurality of different objects, items, and/or property.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system may be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A damage assessment (DA) computing device comprising at least one memory and at least one processor in communication with the at least one memory, wherein the at least one processor is programmed to:
receive, from a client device communicatively coupled with the DA computing device, data representing a glass related damage claim;
determine characteristics of the damage to the glass by analyzing the received data, the characteristics of the damage including at least:
a type of the damage, and
a size of the damage;
based upon the determined characteristics of the damage, determine a type of repair to fix the damage;
communicate, with the client device, the determined type of repair to fix the damage; and
prompt a user of the client device to accept the type of repair including facilitating scheduling of an appointment to fix the damage.

2. The DA computing device of claim 1, wherein the at least one processor is programmed to determine the characteristics of the damage by analyzing the received data using a computer vision model.

3. The DA computing device of claim 1, wherein the received data includes one or more images or video reels.

4. The DA computing device of claim 1, wherein the at least one processor is further programmed to identify the type of damage to the glass as being one of a long crack, a bull's eye crack, a star crack, or a half-moon crack.

5. The DA computing device of claim 1, wherein in response to the at least one processor determining that the type of damage is a long crack and the size of the long crack is a first value in length, the at least one processor is further programmed to:
determine the type of repair to fix the damage by:
comparing the first value in length with a first threshold length value;
in response to the first value in length exceeding the first threshold length value, determining that the type of repair is a replacement job; and
in response to the first value in length being less than the first threshold length value, determining that the type of repair is a repair job.

6. The DA computing device of claim 5, wherein the first threshold length value is about 15 centimeters in length.

7. The DA computing device of claim 1, wherein in response to the at least one processor determining that the type of damage is a bull's eye crack and the size of the bull's eye crack is a second value in diameter, the at least one processor is further programmed to:
determine the type of repair to fix the damage by:
comparing the second value in diameter with a second threshold diameter value;
in response to the second value in diameter exceeding the second threshold diameter value, determining that the type of repair is a replacement job; and
in response to the second value in diameter being less than the second threshold diameter value, determining that the type of repair is a repair job.

8. The DA computing device of claim 7, wherein the second threshold diameter value is about 2 centimeters in diameter.

9. The DA computing device of claim 1, wherein:
the type of damage is a star crack;
the size or the dimension of the star crack is a third value in diameter; and
the determining the type of repair to fix the damage comprises:
comparing the third value in diameter with a third threshold diameter value;
based upon the comparison indicating the third value in diameter exceeding the third threshold diameter value, determining the type of repair to be a replacement job; and based upon the comparison indicating the third value in length being less than the third threshold length value, determining the type of repair to be a repair job.

10. The DA computing device of claim 9, wherein the third threshold diameter value is about 3 centimeters.

11. The DA computing device of claim 1, wherein:
the type of damage is a half-moon crack;
the size or the dimension of the half-moon crack is a fourth value in diameter; and
the determining the type of repair to fix the damage comprises:
comparing the fourth value in diameter with a fourth threshold diameter value;
based upon the comparison indicating the fourth value in diameter exceeding the fourth threshold diameter value, determining the type of repair to be a replacement job; and
based upon the comparison indicating the fourth value in length being less than the fourth threshold length value, determining the type of repair to be a repair job.

12. The DA computing device of claim 11, wherein the fourth threshold diameter value is about 2.5 centimeters.

13. The DA computing device of claim 1, wherein:
the characteristics of the damage further includes a location of the damage, and
the determining the type of repair further comprises determining the type of repair based upon the location of the damage.

14. A computer-implemented method, comprising:
receiving, at a damage assessment (DA) computing device from a client device communicatively coupled with the DA computing device, data representing a glass related damage claim;
based upon the received data, determining characteristics of the damage to the glass, the characteristics of the damage including at least:
a type of the damage, and
a size of the damage;
based upon the determined characteristics of the damage, determining a type of repair to fix the damage;
transmitting, from the DA computing device to the client device, the determined type of repair to fix the damage;
prompting a user of the client device to accept the type of repair including facilitating scheduling of an appointment to fix the damage.

15. The computer-implemented method of claim 14, wherein the determining the characteristics of the damage comprises analyzing the received data using a machine-learning model.

16. The computer-implemented method of claim 15, wherein the machine-learning model is a computer vision model.

17. The computer-implemented method of claim 14, wherein the characteristics of the damage further includes a location of the damage.

18. A non-transitory computer-readable storage media having computer-executable instructions embodied thereon, wherein when executed by at least one processor, the computer-executable instructions cause the at least one processor to:
receive and analyze data representing a glass related damage claim;
based upon the analyzed data, determine characteristics of the damage to the glass, the characteristics of the damage including at least:
a type of the damage, and
a size of the damage;
based upon the determined characteristics of the damage, determine a type of repair to fix the damage;
communicate the determined type of repair to fix the damage to a submitter of the glass related damage claim; and
prompt the submitter to accept the type of repair including facilitating scheduling of an appointment to fix the damage.

19. The non-transitory computer-readable storage media of claim 18, wherein the received data includes visual data, and the visual data is analyzed using a machine-learning model trained using historical claims data.

20. The non-transitory computer-readable storage media of claim 18, wherein the type of repair is determined further in accordance with a location of the damage.
